(19) United States
(12) Patent Application Publication
(10) Pub. No.: US 2010/0191905 A1
(43) Pub. Date: Jul. 29, 2010

(54) STORAGE DEVICE, CONTROL METHOD AND CONTROLLER

(75) Inventor: Hiroshi Tsurumi, Kawasaki-shi (JP)

Correspondence Address: KNOBBE MARTENS OLSON & BEAR LLP, 2040 MAIN STREET, FOURTEENTH FLOOR, IRVINE, CA, 92614, US

(73) Assignee: TOSHIBA STORAGE DEVICE CORPORATION, Tokyo (JP)

(21) Appl. No.: 12/667,849

(22) PCT Filed: Jul. 6, 2007
(86) PCT No.: PCT/JP2007/063546

§ 371 Date: Jan. 5, 2010

(51) Int. Cl. G06F 12/00; G11B 21/02; G06F 12/02

(52) U.S. Cl. 711/112; 360/75; 711/170; 711/E12.001

(57) ABSTRACT

A storage device comprises a recording/reproducing module which positions a head at an arbitrary position of a storage medium to record or reproduce data and a nonvolatile memory in which a parameter storage area is defined. An adjustment module adjusts various types of parameters necessary for controlling a positioning control module and the recording/reproducing module. A parameter save processing module saves adjusted parameters obtained by the adjustment module in the nonvolatile memory during adjustment, while leaving the minimum number of the adjusted parameters necessary to access a system area of the storage medium at the end of the parameter adjustment, and saves the remaining adjusted parameters in the system area of the storage medium to form a free area in the parameter storage area of the nonvolatile memory. The free area processing module uses the free area of the nonvolatile memory as a storage area for firmware, a log or the like other than the parameters.

### TECHNICAL FIELD

The invention relates to a storage device which adjusts and saves various parameters necessary for controlling an apparatus, a control method, and a controller. More particularly, it relates to a storage device for minimizing adjusted parameters to be saved in a nonvolatile memory, a control method, and a controller.

### BACKGROUND ART

Heretofore, as to a magnetic disk drive, various models of storage capacities are often prepared for the same drive type, and a desired storage capacity can be obtained by the appropriate combination of the number of heads and the number of magnetic disks.

Moreover, with the increase of the recording density of the magnetic disk drive and the shortening of an access time, various models of storage capacities are prepared for the same drive type, and control functions required for firmware to control the magnetic disk drive also increase for each drive type, and accordingly various parameters required for the firmware tend to increase.

On the other hand, the characteristics of the heads and magnetic disks are various, and for example, the heads have different read signal levels, and hence gains of a voltage gain control amplifier provided in a read channel need to be adjusted for each head. Moreover, if the heads have different write abilities, respectively, it is necessary to adjust, for each head, a write current of a head driver, the write pre-compensation or the like of the read channel. The write pre-compensation beforehand compensates a phenomenon where an actual write position is observed as if it shifts from a target position.

Furthermore, if the heads have different mechanical resonance characteristics, respectively, it is necessary to adjust, for each head, the notch filter characteristics of a servo system which controls a voice coil motor of a rotary actuator to position the head on a target track.

Additionally, in recent years, the track recording density (TPI) or the data transfer speed has been varied in accordance with the core width or read/write ability of the head, and hence the heads have different track recording densities or sector format information items, respectively. Therefore, each of the heads need to be adjusted to have different optimum parameters.

Examples of typical parameters in reading which is set for each head include a read frequency, a sense current of a TMR head, an AGC gain, a cut-off frequency of a filter, a boost value of the filter for emphasizing a high frequency band, a tap coefficient of an FIR filter for performing automatic equalization or the like, and a vertically asymmetric correction of a regeneration waveform.

Examples of typical parameters in writing which is set for each head include a write frequency, a write pre-compensation, a write current, and an overshoot of the write current.

Furthermore, in recent years, there has been employed head flying height control where a heater element is provided on the head and the heater is heated and controlled to adjust a head flying height to an optimum value of the order of several nanometers. A DAC value for controlling the heater needs to be adjusted to obtain the optimum flying height for each head.

On the other hand, when the magnetic disk drive is manufactured, in an adjustment step after the completion of assembling, various parameters are downloaded together with the firmware which is the control program of the device from adjustment equipment. However, a predetermined performance cannot be obtained with the unadjusted default parameters downloaded from the adjustment equipment, and hence the firmware for adjusting the parameters is downloaded and executed to optimize the parameters for each head or for each zone of the magnetic disk.

In the case of the magnetic disk drive for a mobile phone, all of the adjusted parameters thus obtained in the adjustment step are saved in a system area of each magnetic disk. However, in the case of the magnetic disk drive for an enterprise such as a server in which a high recording density and a high performance are requested, the drive speeds up the processing of saving all of the adjusted parameters together with the firmware in a nonvolatile memory such as a flash ROM, and the processing of loading the necessary parameters into a volatile memory to set the parameters to a head IC, a hard disk controller, a read channel and the like, whereby the loading of the parameters necessary for the head IC, the hard disk controller, the read channel and the like can be speeded up.

That is, the adjusted parameters saved in the nonvolatile memory are read from the nonvolatile memory and loaded into a volatile memory such as an SRAM, when the power of the magnetic disk drive is turned on. Then, a spindle motor is first started up to rotate the magnetic disk at a constant speed, thereby bringing the disk into a readable/writable state. Afterward, on receiving a read command or a write command from a host, the parameters necessary for the head IC, the hard disk controller, the read channel and the like are read from the volatile memory and set, and while the head is positioned on the target track of the magnetic disk, data is read or written.

It is to be noted that Patent Documents 1 and 2 describe that various parameters used in a magnetic disk drive are stored in the system area of a magnetic disk.

Patent Document 1: Jpn. Pat. Appln. KOKAI Publication No. 2001-195196

Patent Document 2: Jpn. Pat. Appln. KOKAI

Publication No. 2007-087484

### DISCLOSURE OF INVENTION

### Technical Problem

However, in a magnetic disk drive in which all of adjusted parameters are saved in a nonvolatile memory as described above, functions required for firmware for controlling the magnetic disk drive increase in each of drive types. However, as to the nonvolatile memory in which the firmware and the adjusted parameters are stored, the decrease of a memory capacity is demanded for cost reduction. As long as the adjusted parameters are stored in the nonvolatile memory, the saving of the adjusted parameters oppresses the nonvolatile memory with the increase of the functions of the firmware. In the case of adding a new control function to the firmware, there is the problem that the capacity of the nonvolatile memory has to be increased.

To solve this problem, it is suggested that all of the adjusted parameters be stored in a system area of a magnetic disk. However, all of the adjusted parameters cannot be saved in the system area of the magnetic disk in the case of the magnetic disk drive for an enterprise such as a server in which a high recording density and a high performance are required.

Moreover, even in the middle of an adjustment step, the adjusted parameters need to be saved if necessary. For example, when the adjustment step is discontinued or stopped on the way, the adjusted parameters are saved in the system area of the magnetic disk to avoid the labor of readjustment.

However, the saving of adjusted data in the system area of the magnetic disk in the middle of the adjustment is the saving of writing in the system area while partially using default parameters at the point of time when all of the parameters are not adjusted. In a certain head, a write error occurs, and the parameters might not normally be written in the system area, which causes the problem that the saving of the adjusted parameters fails during the adjustment and much labor and time are required for the adjustment of the parameters.

An object of the invention is to provide a storage device which can minimize the adjusted parameters to be saved in the nonvolatile memory to enable the storage of data other than the parameters, thereby appropriately coping with the increase of the functions of the firmware or the like, and to provide a control method and a controller.

### Solution to Problem

### (Storage Device)

According to the invention, there is provided a storage device. The storage device comprises: a recording/reproducing module configured to position a head at an arbitrary position of a storage medium to record or reproduce data; a nonvolatile memory in which a parameter storage area is defined; an adjustment module configured to adjust various types of parameters necessary for the control of the recording/reproducing module; a parameter save processing module configured to save the adjusted parameters obtained by the adjustment module in the nonvolatile memory during adjustment and to save, in the storage medium, part of the adjusted parameters stored in the nonvolatile memory at the end of the parameter adjustment to form a free area in the parameter storage area; and a free area processing module configured to use the free area of the nonvolatile memory as a storage area for data other than the parameters. The parameter save processing module is configured to leave, in the nonvolatile memory, minimum parameters necessary to read data from a system area of the storage medium at the startup of the device by power activation, and to save remaining parameters in the storage medium. The nonvolatile memory is provided with a flag having a reset state as an initial state in the parameter storage area; and the parameter save processing module is configured to set the flag when part of the adjusted parameters saved in the nonvolatile memory is written and saved in the storage medium. The parameter save processing module is configured to save all of the adjusted parameters in the nonvolatile memory in a case where the flag is reset when the save command for the adjusted parameters is received, and to dividedly save the adjusted parameters in the nonvolatile memory and the storage medium in accordance with the contents of the adjusted parameters in a case where the flag is set. The storage device comprises a parameter load processing module configured to read the adjusted parameters from the nonvolatile memory and the storage medium in accordance with the state of the flag at the startup by the power activation, to load the adjusted parameters into a volatile memory. The parameter load processing module is configured to load all of the parameters into the volatile memory from the nonvolatile memory when the flag is reset at the startup by the power activation, and to load part of the parameters into the volatile memory from the nonvolatile memory and loads the remaining parameters into the volatile memory from the storage medium when the flag is set. The free area processing module is configured to use the free area as a storage area for firmware or a storage area for a log.

### (Control Method for a Storage Device)

According to the invention, there is provided a control method for a storage device which comprises a recording/reproducing module configured to position a head at an arbitrary position of a storage medium to record or reproduce data and a nonvolatile memory in which a parameter storage area is defined. The control method comprises: an adjustment process which adjusts various types of parameters necessary for the control of the recording/reproducing module; a parameter save process which saves the adjusted parameters obtained by the adjustment process in the nonvolatile memory during adjustment and which saves, in the storage medium, part of the adjusted parameters stored in the nonvolatile memory at the end of the parameter adjustment to form a free area in the parameter storage area; and a free area process which uses the free area of the nonvolatile memory as a storage area for data other than the parameters.

### (Controller)

According to the invention, there is provided a controller for controlling a storage device which positions a head at an arbitrary position of a storage medium to record or reproduce data. The controller comprises: an adjustment module configured to adjust various types of parameters necessary for the control of the recording/reproducing; a parameter save processing module configured to save the adjusted parameters obtained by the adjustment module in a nonvolatile memory during adjustment and to save, in the storage medium, part of the adjusted parameters stored in the nonvolatile memory at the end of the parameter adjustment to form a free area in a parameter storage area defined in the nonvolatile memory; and a free area processing module configured to use the free area of the nonvolatile memory as a storage area for data other than the parameters.

### ADVANTAGEOUS EFFECTS OF INVENTION

According to the invention, at the end of a parameter adjustment step, minimum adjusted parameters necessary for reading data from a system area of a storage medium at the startup of a device are saved in a nonvolatile memory, and remaining adjusted parameters are saved in a storage area of the storage medium. In consequence, part of a parameter storage area of the nonvolatile memory used to save the adjusted parameters during adjustment is acquired as a free area. This free area can be used to store data, such as code, a log and the like, other than the parameters in compliance with the increase of the functions of firmware. For example, a storage area involving the increase of the functions of the firmware can be acquired without increasing the capacity of the nonvolatile memory, which can cope with the increase of the functions of the firmware without incurring any cost rise due to the capacity increase of the nonvolatile memory.

### BRIEF DESCRIPTION OF DRAWINGS

FIG. 1 is a block diagram showing a magnetic disk drive in an embodiment of a storage device according to the invention;

FIG. 2 is an explanatory view showing an internal structure of the magnetic disk drive according to the embodiment;

FIG. 3 is an explanatory view showing storage areas of a magnetic disk in the embodiment;

FIG. 4 is an explanatory view showing a table of parameters to be loaded into a volatile memory from a nonvolatile memory and a magnetic disk in the embodiment;

FIG. 5 is an explanatory view showing a detailed list of read parameters, write parameters and servo parameters in the parameter table of FIG. 4;

FIG. 6 is a memory map explanatory view showing the storage states of the volatile memory, the nonvolatile memory and the magnetic disk during adjustment in the embodiment;

FIG. 7 is a memory map explanatory view showing the state that part of adjusted parameters is saved in the nonvolatile memory at the end of the adjustment according to the embodiment;

FIG. 8 is a memory map explanatory view showing the state that part of the adjusted parameters is saved in a system area of the magnetic disk at the end of the adjustment according to the embodiment;

FIG. 9 is an explanatory view showing the state that a restoration code is saved in a free area of the nonvolatile memory according to the embodiment;

FIG. 10 is a memory map explanatory view showing the state that the adjusted parameters are saved in an adjustment step of the embodiment and the power of the device is turned off;

FIG. 11 is a memory map explanatory view showing a process for loading the adjusted parameters from the nonvolatile memory when the power of the device is turned on in the state of FIG. 10;

FIG. 12 is an explanatory view, continued from FIG. 11, showing a process for loading the adjusted parameters from the magnetic disk;

FIG. 13 is a memory map explanatory view showing recovery processing which uses the restoration code saved in the free area when an error of firmware in the nonvolatile memory occurs;

FIG. 14 is a flow chart showing parameter adjustment processing in the magnetic disk drive according to the embodiment; and

FIG. 15 is a flow chart, continued from FIG. 14, showing the parameter adjustment processing.

### BEST MODE FOR CARRYING OUT THE INVENTION

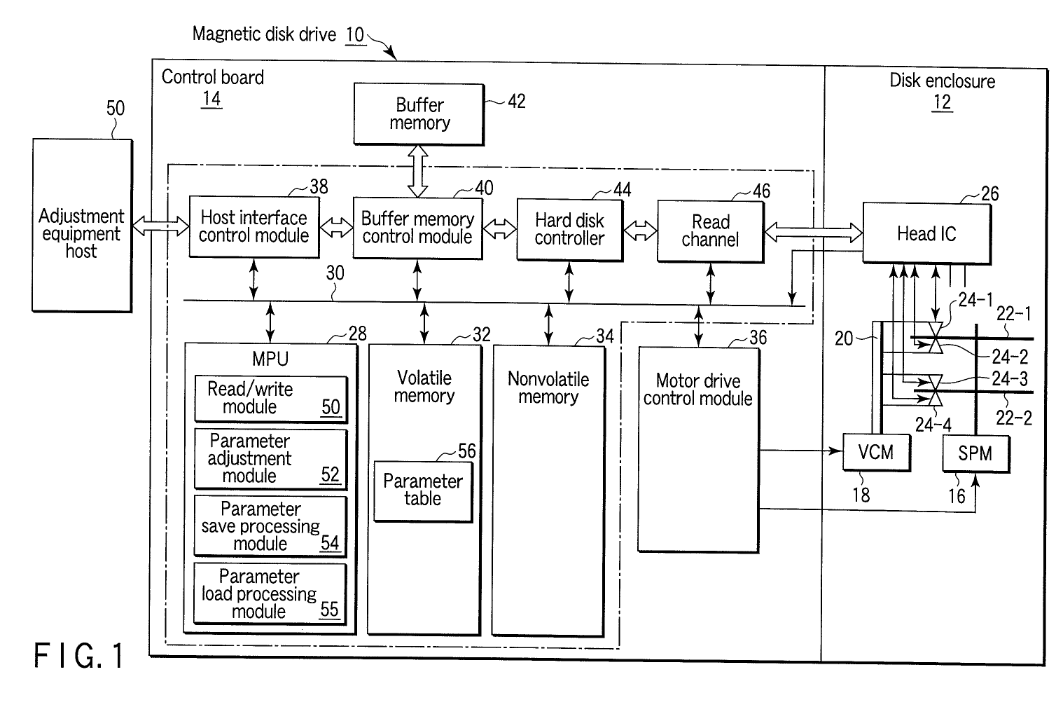

FIG. 1 is a block diagram showing a magnetic disk drive according to an embodiment of a storage device of the invention for processing a parameter adjustment in an adjustment step during manufacturing.

In FIG. 1, a magnetic disk drive 10 which is known as a hard disk drive (HDD) comprises a disk enclosure 12 and a control board 14. The disk enclosure 12 is provided with a spindle motor 16. Magnetic disks (disk mediums) 22-1 and 22-2 are attached to a rotary shaft of the spindle motor 16 and rotated at a constant speed of, for example, 10000 rpm.

Moreover, the disk enclosure 12 is provided with a voice coil motor 18. Heads 24-1 to 24-4 are mounted on the arm tips of a rotary actuator 20 of the voice coil motor 18 and positioned with respect to the recording surfaces of the magnetic disks 22-1 and 22-2.

Each of the heads 24-1 to 24-4 is a composite type head in which a recording element and a read element are integrated. As the recording element, a longitudinal (in-plane) magnetic recording type recording element or a perpendicular magnetic recording type recording element is used. In the case of the perpendicular magnetic recording type recording element, a perpendicular recording medium including a recording layer and a soft magnetic backing layer is used for the magnetic disks 22-1 and 22-2. As the read element, a magnetoresistive element such as a GMR element or a TMR element is used.

The heads 24-1 to 24-4 are connected to a head IC 26 via signal lines, and the head IC 26 selects one head by a head selection signal based on the write command or the read command from the host which is a higher-level device, to perform writing or reading. Moreover, the head IC 26 is provided with a write driver for a write system and a preamplifier for a read system.

The control board 14 is provided with an MPU 28, and a bus 30 of the MPU 28 is connected to a volatile memory 32 using an RAM into which firmware provided with control program and control data and a parameter table 56 are loaded, and a nonvolatile memory 34 using a flash RAM or the like in which firmware, parameters and the like are stored.

Moreover, the bus 30 of the MPU 28 is connected to a motor drive control module 36 which controls the spindle motor 16 and the voice coil motor 18; a host interface control module 38; a buffer memory control module 40 which controls a buffer memory 42; a hard disk controller (HDC) 44 which functions as a formatter; and a read channel (RDC) 46 which functions as a write modulation module, a read modulation module and a servo demodulation module.

Furthermore, the MPU 28, the volatile memory 32, the nonvolatile memory 34, the host interface control module 38, the buffer memory control module 40, the hard disk controller 44 and the read channel 46 provided in the control board 14 constitute a control circuit 48, and the control circuit 48 is realized as one LSI circuit.

It is to be noted that in accordance with the mounting area of the control board 14, various control circuits, that is, the MPU 28, the host interface control module 38, the buffer memory control module 40, the hard disk controller 44 and the read channel 46 can be constituted by individual LSI circuits, or a plurality of control circuits such as the MPU 28, the hard disk controller 44 and the read channel 46 may be selected to constitute one LSI circuit.

When the assembling of a device including the disk enclosure 12 and the control board 14 is completed in a manufacturing step of the magnetic disk drive 10, processing advances to an adjustment step in which the assembled magnetic disk drive 10 is connected to an adjustment equipment host 11 as shown in FIG. 1, to perform adjustment processing.

In the adjustment step, the adjustment equipment host 11 downloads the firmware which is the control program of the magnetic disk drive 10 and a default parameter table necessary for the control of the magnetic disk drive 10 in the volatile memory 32 via the host interface control module 38 and the buffer memory 42, to execute the adjustment firmware, thereby executing parameter adjustment processing to adjust default parameters to optimum parameters for the magnetic disk drive 10.

Here, the firmware downloaded from the adjustment equipment host 11 is executed by the MPU 28 to realize the functions of a read/write module 50, a parameter adjustment module 52, a parameter save processing module 54 and a parameter load processing module 55 disposed in the MPU 28.

Among these functions, the functions realized by the firmware for parameter adjustment are the functions of the parameter adjustment module 52, the parameter save processing module 54 and the parameter load processing module 55 excluding the read/write module 50. When the parameter adjustment processing ends, the firmware for parameter adjustment is considered to be unnecessary and thus deleted. After the deletion, the inherent function of the firmware for realizing the function of the read/write module 50 remains.

The read/write module 50 selects the head based on the analysis of command parameters of the read command or the write command received from the host, to position the head in a target track on the magnetic disk, thereby recording or reproducing the data. At this time, the read/write module 50 reads write parameters from the parameter table 56 loaded into the volatile memory 32 during the recording, to set the parameters in the hard disk controller 44, the read channel 46 and the head IC 26. During the reproduction, the read/write module 50 reads read parameters to set the parameters in the hard disk controller 44, the read channel 46 and the head IC 26. These parameters are adjusted to optimum values in the adjustment step, and hence the data is recorded or reproduced by using the optimum parameters in accordance with the head and the zone on the magnetic disk.

The parameter adjustment module 52 adjusts various parameters necessary for the control of the read/write module 50 by the execution of the firmware for adjustment downloaded from the adjustment equipment host 11.

Specifically, the parameter adjustment module 52 adjusts the parameters so as to obtain the optimum values of the default parameters stored in the default parameter table 56 downloaded from the adjustment equipment host 11 while actually recording or reproducing, for example, test data in or from the magnetic disk.

The parameter save processing module 54 saves all of the adjusted parameters obtained by the parameter adjustment module 52 in the nonvolatile memory 34 during the adjustment, and saves part of the adjusted parameters saved in the nonvolatile memory 34 in, for example, a system area of the recording surface of the magnetic disk 22-1 corresponding to the head 24-1 at the end of the parameter adjustment, whereby part of a parameter storage area of the nonvolatile memory 34 is acquired as a free area.

The parameter load processing module 55 uses the free area of the nonvolatile memory 34 acquired by saving the parameters in the magnetic disk system area as a storage area for data other than the parameters, for example, code of the firmware or a log.

Here, the adjustment of the parameters finishes, and then the magnetic disk drive 10 is shipped from the factory and delivered to the user. Next, the subsequent usual operation of the magnetic disk drive 10 with respect to the commands from the host will be described.

On receiving the write command and write data from the host by the host interface control module 38, the magnetic disk drive 10 decodes the write command by the MPU 28, recognizes the head number corresponding to the target track and the zone number of the magnetic disk, and drives the VCM 18 by the motor drive control module 36. If, for example, the head 24-1 corresponding to the magnetic disk 22-1 is selected, the head 24-1 is moved to the target track designated by the command, to perform control for positioning the head 24-1 on the target track.

At the completion of the seek operation for moving the head 24-1 to the target track, the hard disk controller 44 converts the write data stored in the buffer memory 42 into a predetermined data format. Moreover, an ECC code is added the write data by ECC coding processing, and the write data is converted into a scramble RLL code by a write modulation system in the read channel 46, and write compensation is further performed. Afterward, a write current is supplied to the recording element provided in, for example, the selected head 24-1 from the write amplifier via the write driver of the head IC 26, to write the data to the magnetic disk 22-1.

On the other hand, on receiving the read command from the host by the host interface control module 38, the magnetic disk drive 10 decodes the read command by the MPU 28, recognizes the head number and the zone number from the address of the target track, and drives the VCM 18 by the motor drive control module 36. If, for example, the head 24-1 corresponding to the magnetic disk 22-1 is selected, the head 24-1 is moved to the target track designated by the command, to perform control for positioning the head 24-1 on the target track.

A read signal output from the read element of the head 24-1 selected by the head IC 26 during the on-track control is amplified by the preamplifier, and then input into a read demodulation system of the read channel 46.

In the read demodulation system of the read channel 46, a variable gain amplifier amplifies the head read signal obtained via the preamplifier of the head IC 26 by automatic gain control, and an AD converter samples the signal as digital data via a low pass filter. The read data is demodulated by automatic equalization Viterbi detection constituted by an FIR filter and a maximum likelihood detector, partial response maximum likelihood (PRML) detection and the like, further converted into an RLL decode, and descrambled. The hard disk controller 44 performs ECC decode processing to correct an error. Afterward, the read data is buffered in the buffer memory 42, and transferred from the host interface control module 38 to the host.

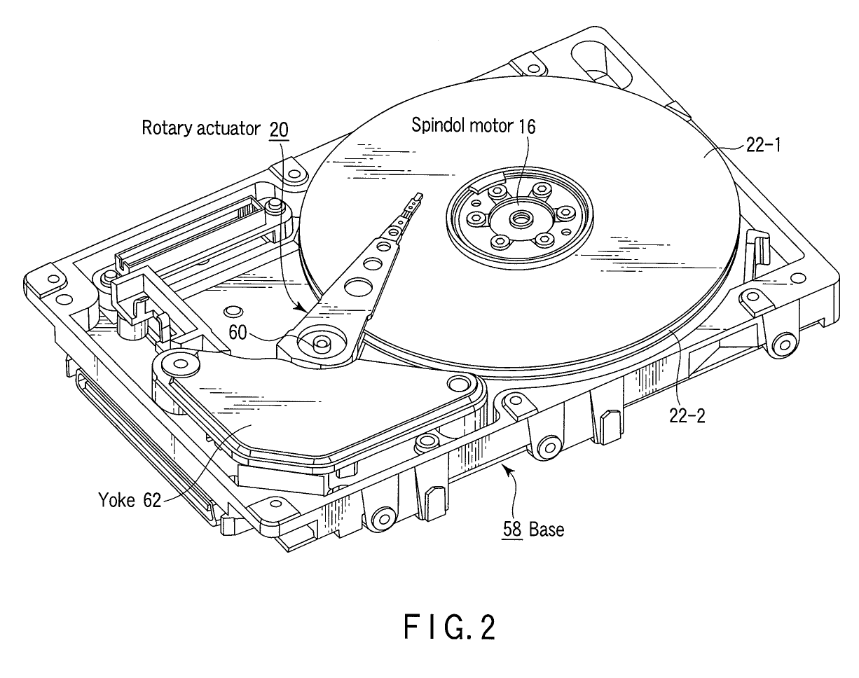

FIG. 2 is an explanatory view of an internal structure of the magnetic disk drive in the embodiment. In FIG. 2, the magnetic disk drive of the embodiment is provided with the magnetic disks 22-1 and 22-2 arranged on a base 58 and rotated at a constant speed by the spindle motor 16.

With respect to the magnetic disks 22-1 and 22-2, the rotary actuator 20 rotatably supported by a shaft portion 60 is disposed. The tip of an arm of the rotary actuator 20 is provided with the head 24-1, and a coil provided on the opposite side of the arm is rotatably disposed between upper and lower yokes 62 fixed to the base 58 together with a permanent magnet, thereby constituting the voice coil motor.

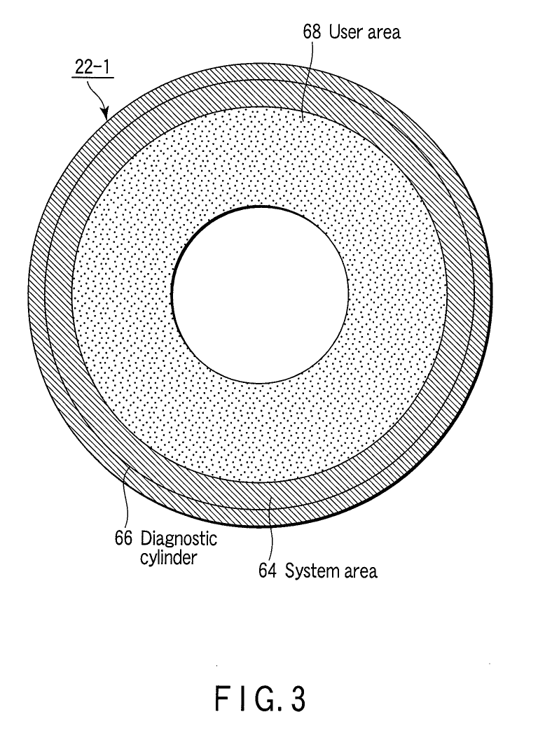

FIG. 3 is an explanatory view showing storage areas of the magnetic disk in the embodiment. In FIG. 3, the magnetic disk 22-1 has two recording surfaces, that is, a front recording surface shown in the drawing and a back recording surface. In the shown front recording surface, a system area 64 is set on the outer circumference side thereof, and a user area 68 is set on the inner side of the system area 64. The system area 64 is provided with a diagnostic cylinder 66.

In the system area 64, the firmware including the control program and control data for controlling the magnetic disk drive is stored. In the embodiment, however, firmware necessary for starting up the magnetic disk drive at the time of power activation is stored in the nonvolatile memory 34 of FIG. 1, and the remaining firmware is stored in the system area 64 of the magnetic disk 22-1 of FIG. 3.

Furthermore, in the embodiment, as to the adjusted parameters processed in the adjustment step during the manufacturing and saved in the nonvolatile memory 34 at the end of the adjustment, the only read parameters necessary for reading the data from the system area 64 at the time of the power activation are stored in the nonvolatile memory 34, and the other remaining adjusted parameters are stored in the system area 64.

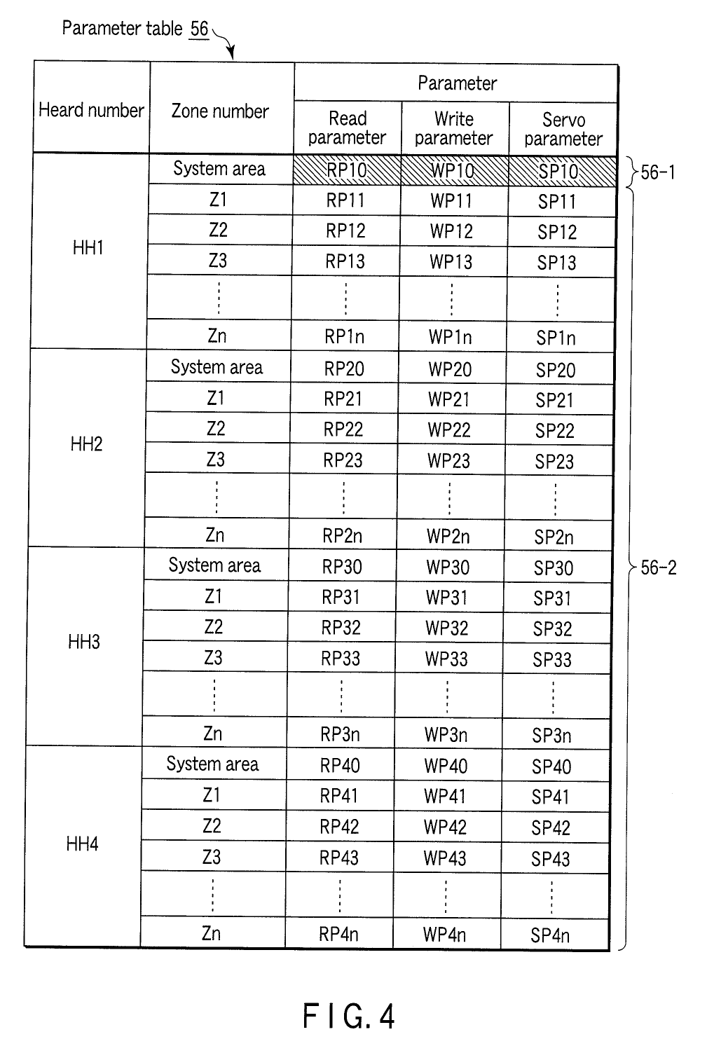

FIG. 4 is an explanatory view showing a table of parameters loaded into the volatile memory from the nonvolatile memory and the magnetic disk at the time of the power activation in the embodiment. In FIG. 4, the parameter table 56 is divided based on head numbers, that is, head numbers HH1 to HH4 because the four heads 24-1 to 24-4 are used in the embodiment.

For each of the head numbers HH1 to HH4, zone numbers are allocated to the system area and zones Z1 to Zn as zone numbers. Thus, parameters are stored in an area corresponding to the head number and the zone number. The parameters are three types, that is, the read parameter, the write parameter and a servo parameter.

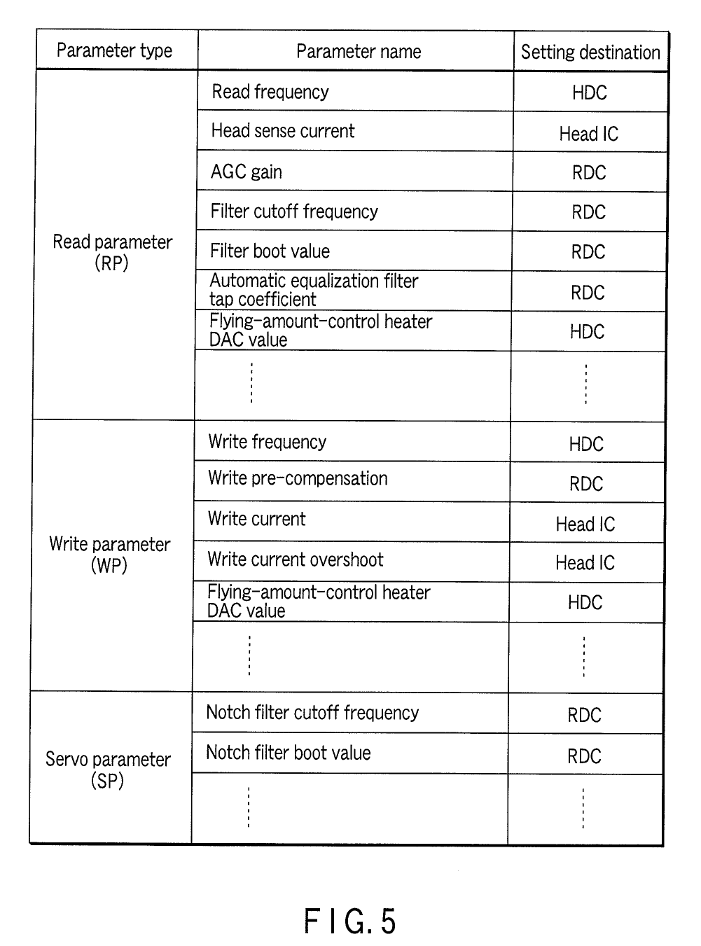

FIG. 5 is an explanatory view showing a detailed list of the read parameters, write parameters and servo parameters in the parameter table 56 of FIG. 4.

In FIG. 5, examples of a typical read parameter (RP) include a read frequency, a head sense current, an AGC gain, a filter cut-off frequency, a filter boot value, an automatic equalization filter tap coefficient (FIR filter tap coefficient), and a heater DAC value for controlling a flying height. As destinations in which these read parameters are set, a hard disk controller (HDC), a head IC and a read channel (RDC) are shown on the right side of the table.

Examples of the write parameter (WP) include a write frequency, write pre-compensation (write compensation), a write current, write current overshoot, and the heater DAC value for controlling the flying height. Furthermore, examples of the servo parameter (SP) include a notch filter cut-off frequency and a notch filter boot value.

When the parameter table 56 including such read parameters, write parameters and servo parameters shown in FIG. 5 is downloaded together with the firmware from the adjustment equipment host 11 in FIG. 1, the default parameters beforehand prepared based on design data or statistic data are stored in the parameter table 56. However, the default parameters do not necessarily correspond to the fluctuations of the heads of the device or the mediums of the device, and hence adjustment processing is performed in the adjustment step.

In this adjustment processing, the test data is written in a predetermined test track and then read therefrom by use of default write and read parameters as initial values, and the parameters are adjusted so as to maximize, for example, Viterbi trellis margin (VTM) which is a signal quality monitor value obtained from a quality monitor portion of the read channel 46, whereby the optimum parameters are acquired as the adjusted parameters.

Referring again to FIG. 4 for the adjusted parameter table 56, in the embodiment, the whole parameter table 56 is saved in the nonvolatile memory 34 during the adjustment, but at the end of the adjustment, the only adjusted parameters necessary for reading the data from the system area are left in the nonvolatile memory 34, the other adjusted parameters are saved in the system area 64 of the magnetic disk 22-1 shown in FIG. 3, and the parameters saved in the system area 64 are deleted from the nonvolatile memory 34 to form the free area.

Specifically, in the parameter table 56 of FIG. 4, a read parameter PR10, a write parameter WP10 and a servo parameter SP10 of a table area 56-1 corresponding to the head number HH1 and the zone number indicating the system area are the parameters necessary for reading the data from the system area 64 of the magnetic disk 22-1. In consequence, the parameters of the table area 56-1 are left in the nonvolatile memory 34, and the other parameters of a table area 56-2 are saved in the system area 64 of FIG. 3.

It is to be noted that the only parameters of the system areas corresponding to all the heads may be left in order to improve a processing efficiency.

Next, the storage states in the volatile memory 32, the nonvolatile memory 34 and the magnetic disk 22-1 in the parameter adjustment processing of the embodiment will be described in detail with reference to memory maps.

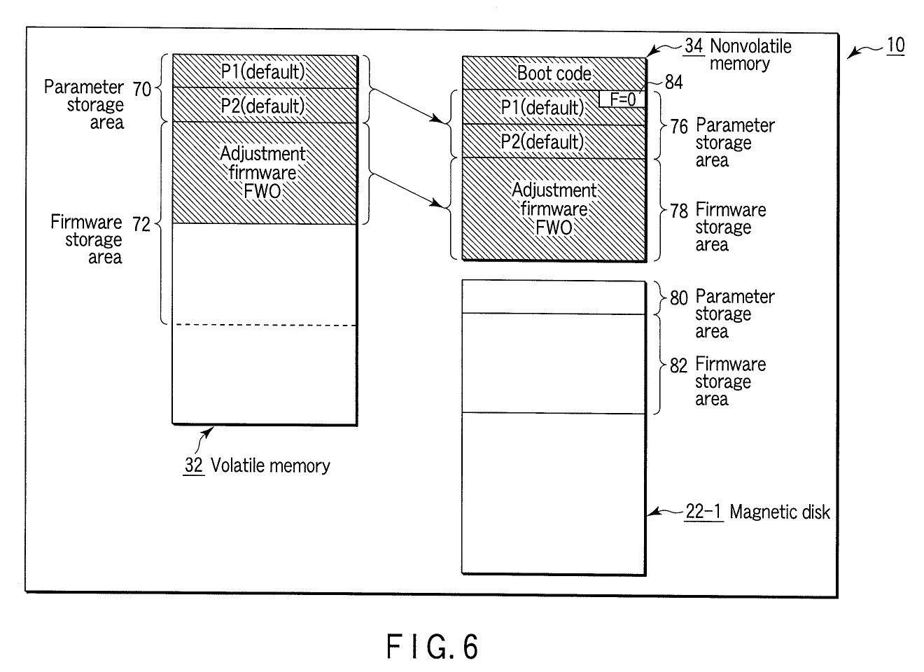

FIG. 6 is a memory map explanatory view showing the storage states of the firmware and the parameters in the volatile memory 32, the nonvolatile memory 34 and the magnetic disk 22-1 during the parameter adjustment in the embodiment.

In the volatile memory 32 of FIG. 6, a parameter storage area 70 and a firmware storage area 72 are defined. Prior to the adjustment step, adjustment firmware FW0, default parameters P1 and P2 downloaded from the adjustment equipment host 11 are loaded into the nonvolatile memory via the buffer memory 42, and then saved in the nonvolatile memory 34.

Specifically, a download command is implemented in boot code 74 of the nonvolatile memory 34, and at startup by the power activation after the assembling, the download command is executed to download and save the adjustment firmware FW0, default parameters P1 and P2 in the nonvolatile memory 34.

Here, parameters P1 correspond to the minimum parameters, necessary for reading the data from the system area, in the table area 56-1 hatched in FIG. 4. Moreover, parameters P2 correspond to the parameters in the table area 56-2 of FIG. 4.

The nonvolatile memory 34 is, for example, a flash ROM, and the loading/storing in the nonvolatile memory 34 is performed in units of, for example, 8 Kbytes. The boot code 74 is beforehand stored in the top position of the nonvolatile memory 34, and at the time of the power activation, the boot code 74 is read from the nonvolatile memory 34, loaded into the volatile memory 32 and executed by the MPU 28 to execute initialization diagnostic processing.

On the other hand, in the system area of the magnetic disk 22-1, a parameter storage area 80 and a firmware storage area 82 are acquired.

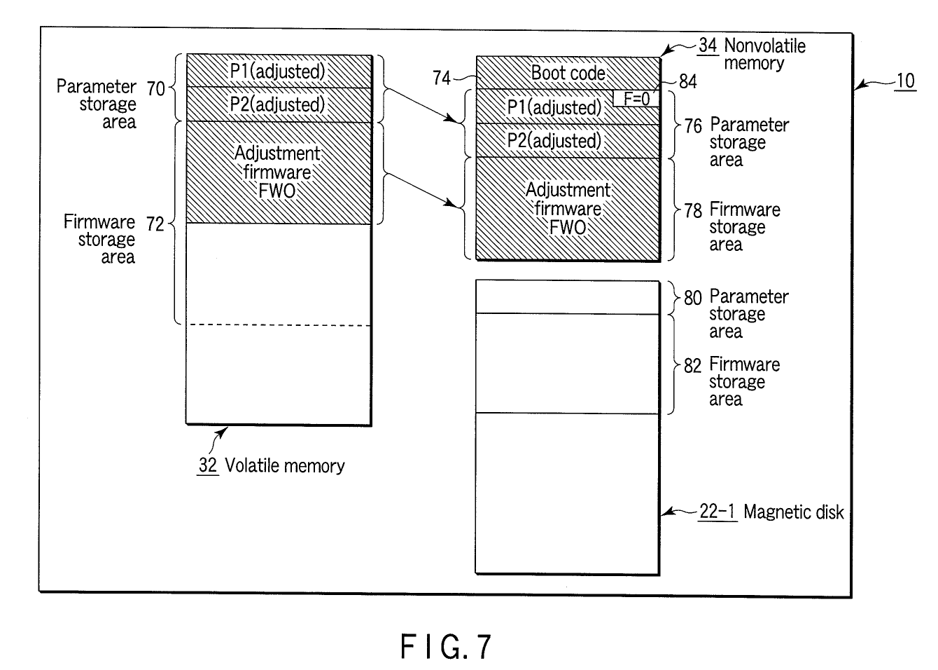

FIG. 7 is a memory map explanatory view for the parameter adjustment according to the embodiment. In FIG. 7, during the parameter adjustment, the default parameters P1 and P2 stored in the parameter storage area 70 of the volatile memory 32 are targets successively subjected to the parameter adjustment processing by the adjustment firmware FW0, and all of parameters P1 and P2 are saved as adjusted parameters P1 and P2 in a parameter storage area 76 of the nonvolatile memory 34.

Adjusted parameters P1 and P2 in the volatile memory 32 are saved in the nonvolatile memory 34 by automatically producing a save command for the adjustment of each parameter determined by the head number and the zone number as shown in, for example, FIG. 4, or saved in the nonvolatile memory 34 on receiving the save command issued from the adjustment equipment host 11 as required.

Here, adjusted parameters P1 saved in the nonvolatile memory 34 are provided with a flag 84. The flag 84 has a reset state, that is, F=0 in an initial state shown in FIGS. 6 and 7.

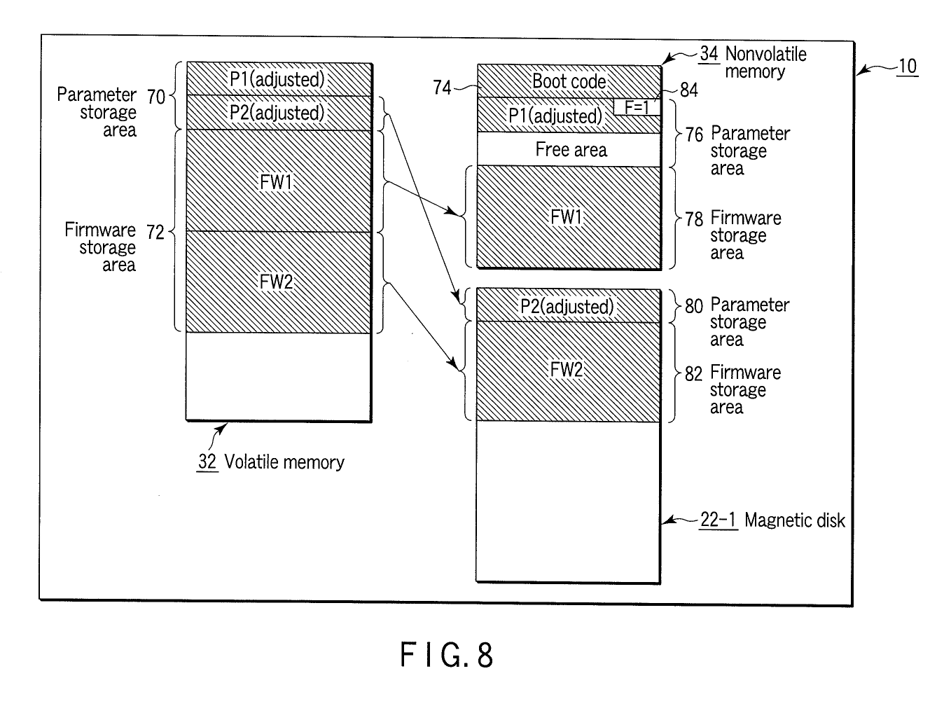

FIG. 8 is a memory map explanatory view showing the state that part of the adjusted parameters is saved in the system area of the magnetic disk from the nonvolatile memory at the end of the adjustment according to the embodiment.

In FIG. 8, when the parameter adjustment processing finishes, adjusted parameters P2 provided in the parameter storage area 70 of the volatile memory 32 and corresponding to the table area 56-2 of FIG. 4 are read and saved in the parameter storage area 80 provided in the system area of the magnetic disk 22-1.

When adjusted parameters P2 are thus saved in the magnetic disk 22-1, the flag 84 provided in the area of adjusted parameters P1 of the nonvolatile memory 34 is set to F=1. Moreover, when adjusted parameters P2 are saved in the magnetic disk 22-1, the area where adjusted parameters P2 have been stored is acquired as a free area 77 of the nonvolatile memory 34.

Simultaneously with the saving of the adjusted parameter in the magnetic disk 22-1, firmware FW2 stored in the firmware storage area 72 of the volatile memory 32 is saved in the firmware storage area 82 of the magnetic disk 22-1.

When the parameter adjustment processing finishes, the download command implemented in the adjustment firmware FW0 is executed to load firmware FW1 and firmware FW2 into the nonvolatile memory from the adjustment equipment host 11 via the buffer memory 42 of FIG. 1. Afterward, firmware FW1 is saved in a firmware storage area 78 of the nonvolatile memory 34, and firmware FW2 is saved in the firmware storage area 82 of the magnetic disk 22-1.

Here, firmware FW1 is firmware necessary at the startup by the power activation of the magnetic disk drive 10. On the other hand, firmware FW2 is firmware required after the spindle motor can start by the power activation to read and write the data from and to the magnetic disk.

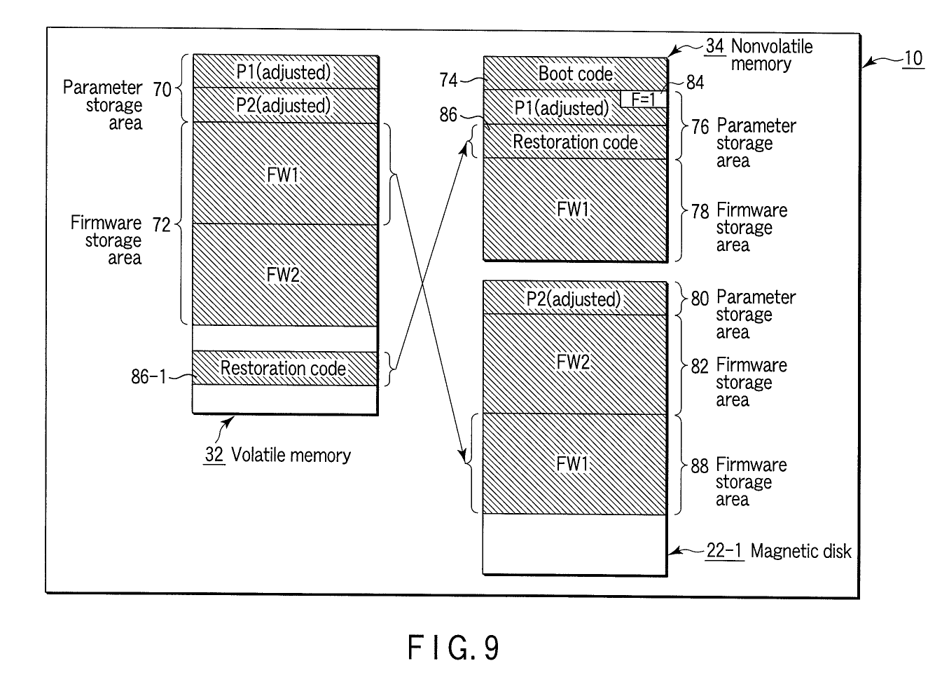

FIG. 9 is an explanatory view showing that a restoration code is saved in the free area of the nonvolatile memory according to the embodiment.

In the embodiment, as shown in FIG. 8, adjusted parameters P2 can be saved in the magnetic disk 22-1 from the volatile memory 32 to acquire the free area 77 in the nonvolatile memory 34. The free area 77 is used as a storage area for data other than the parameter, for example, the storage area for a restoration code newly provided in compliance with the increase of the functions of the firmware in the embodiment.

That is, a restoration code 86-1 in compliance with the increase of the functions of the firmware is downloaded into the volatile memory 32, and the restoration code 86-1 is saved as a restoration code 86 in the free area of the nonvolatile memory 34.

Moreover, since the restoration code 86 is saved in the free area of the nonvolatile memory 34, a firmware storage area 88 is newly provided in the system area of the magnetic disk 22-1, to save the same firmware FW1 as that saved in the nonvolatile memory 34 from the volatile memory 32.

The magnetic disk drive of the embodiment is incorporated and used as a RAID device in a subsystem of the user's computer, and update processing for obtaining new firmware is performed if necessary.

However, if an error occurs to break down the data during the update of the firmware in the nonvolatile memory 34, for example, the flash ROM or the like, a diagnostic error next occurs in the nonvolatile memory 34 at the time of the power reactivation, whereby the firmware cannot start and the device cannot be used.

The restoration code 86 saved in the free area of the nonvolatile memory 34 is executed, if the diagnostic error occurs in diagnostic processing for loading firmware FW1 into the volatile memory 32 from the nonvolatile memory 34 at the time of the power activation of the magnetic disk drive 10.

When the restoration code 86 is executed, as clearly described later, firmware FW1 saved in the firmware storage area 88 of the magnetic disk 22-1 can be loaded into the volatile memory 32 to recover from the error of the nonvolatile memory 34.

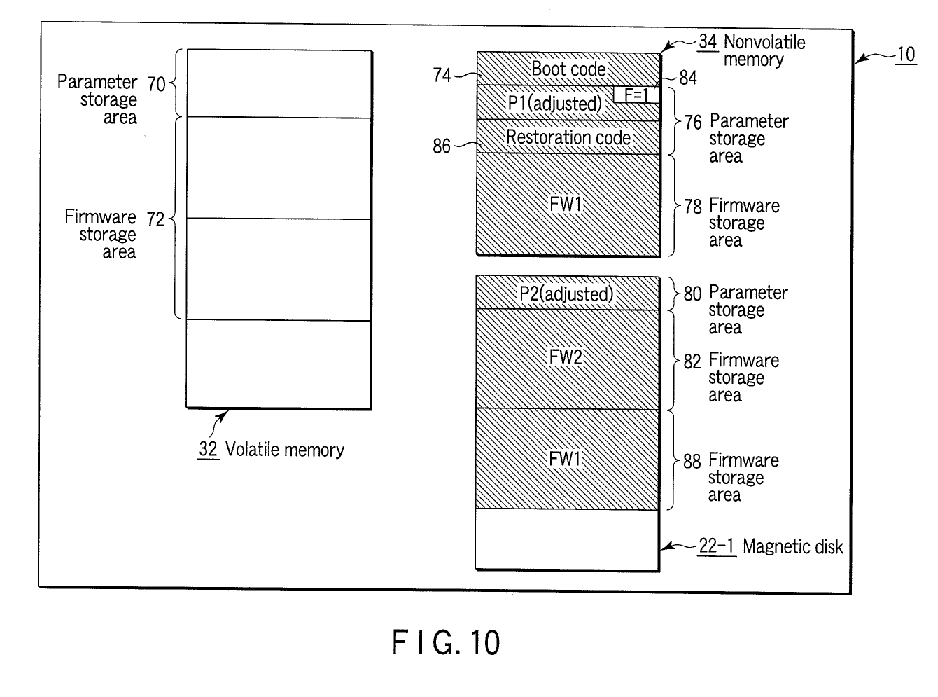

FIG. 10 is a memory map explanatory view showing that the adjusted parameters are saved in the adjustment step of the embodiment and that the power of the device is turned off. In a memory map of FIG. 10 after the power is turned off at the completion of the adjustment step, the boot code 74, adjusted parameters P1 including the only read parameters for the system area of the magnetic disk, the restoration code 86 using the free area and firmware FW1 are stored in the nonvolatile memory 34.

Moreover, adjusted parameters P2 excluding adjusted parameters P1 in the nonvolatile memory 34 are stored in the parameter storage area 80 of the magnetic disk 22-1, and firmware FW2 is stored in the firmware storage area 82. Furthermore, while the restoration code 86 is stored in the nonvolatile memory 34, firmware FW1 for recovery is stored in the firmware storage area 88.

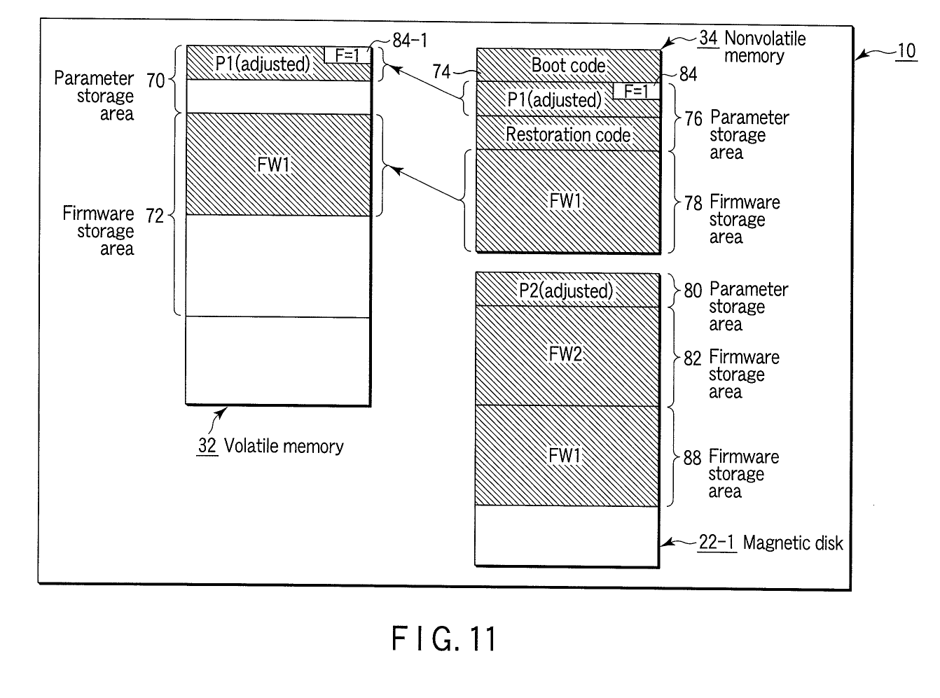

FIG. 11 is a memory map explanatory view showing a process for loading of the adjusted parameters from the nonvolatile memory when the power of the magnetic disk drive is turned on in the state of FIG. 10.

In FIG. 11, when the power of the magnetic disk drive 10 subjected to the parameter adjustment processing is turned on, the boot code 74 in the nonvolatile memory 34 is executed to perform self-diagnostic and initialization processing, and then adjusted parameters P1 are loaded into the volatile memory 32 from the parameter storage area 76. Moreover, firmware FW1 in the firmware storage area 78 of the nonvolatile memory 34 is loaded into the firmware storage area 72 of the volatile memory 32.

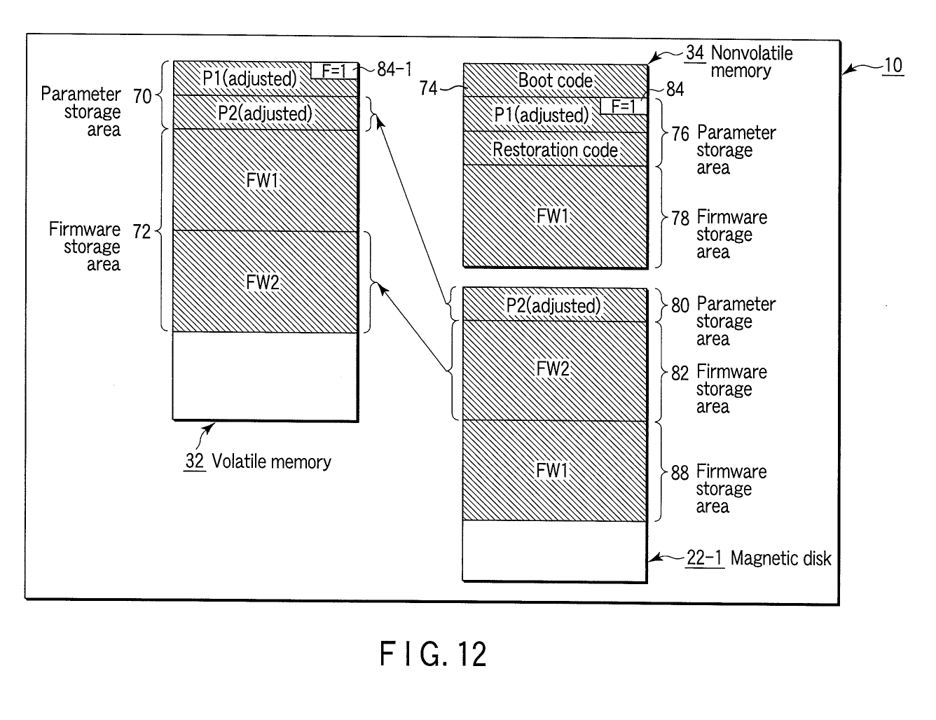

Subsequently, a flag 84-1 provided in adjusted parameters P1 loaded into the volatile memory 32 is checked. When the flag 84-1 is set to F=1, as shown in FIG. 12, adjusted parameters P2 saved in the parameter storage area 80 in the system area of the magnetic disk 22-1 are loaded into the parameter storage area 70 of the volatile memory 32. At this time, firmware FW2 in the firmware storage area 82 of the magnetic disk 22-1 is simultaneously loaded into the firmware storage area 72 of the volatile memory 32.

On the other hand, in FIG. 11, when the flag 84-1 provided in adjusted parameters P1 loaded into the volatile memory 32 has a reset state of F=0, as shown in FIG. 7, adjusted parameters P2 are not saved in the parameter storage area 80 of the magnetic disk 22-1. Therefore, the remaining adjusted parameters P2 are loaded into the volatile memory 32 from the nonvolatile memory 34.

That is, when the flag 84 is reset to F=0, all of adjusted parameters P1 and P2 are loaded into the volatile memory 32 from the nonvolatile memory 34.

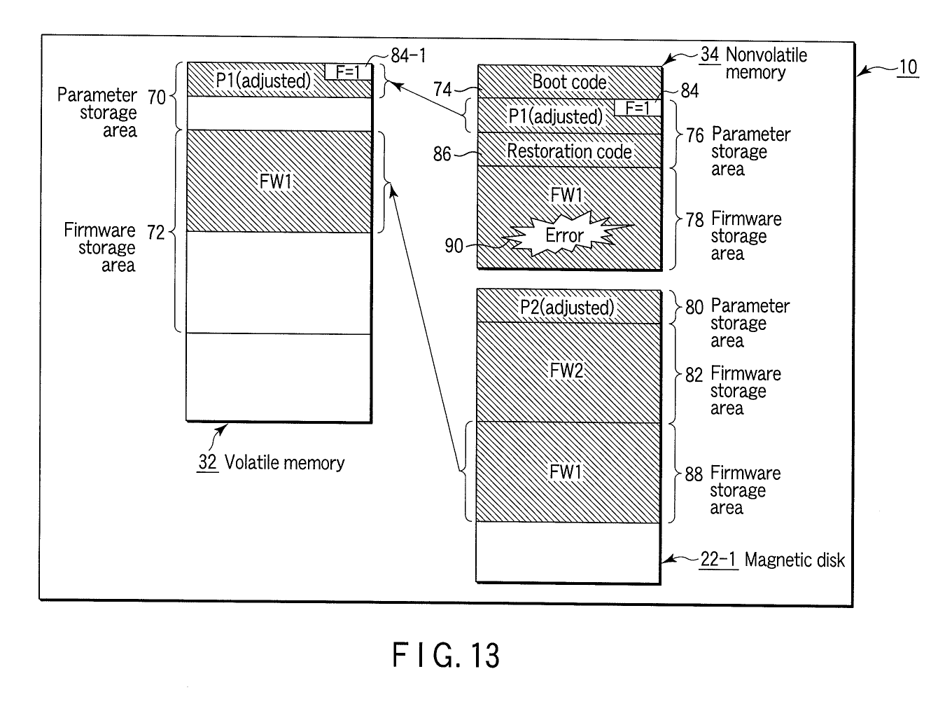

FIG. 13 is a memory map explanatory view showing recovery processing performed by executing the restoration code saved in the free area when the error of the firmware of the nonvolatile memory occurs.

In FIG. 13, the boot code 74 is executed in accordance with the power activation of the magnetic disk drive, and then adjusted parameters P1 are loaded into the volatile memory 32. Next, when the self-diagnosis of firmware FW1 in the firmware storage area 78 is performed and a diagnostic error occurs, the restoration code 86 is executed.

When the restoration code 86 is executed, firmware FW1 saved in the firmware storage area 88 of the magnetic disk 22-1 can be loaded into the volatile memory 32 to recover from the error of firmware FW1 in the nonvolatile memory 34.

Subsequently, in a case where when the flag 84-1 of adjusted parameters P1 loaded into the volatile memory 32 is checked and it is determined that the flag 84-1 is set to F=1, in the same manner as in FIG. 12, adjusted parameters P2 and firmware FW2 are loaded into the volatile memory 32 from the magnetic disk 22-1.

On the other hand, in the adjustment step in which the magnetic disk drive 10 is connected to the adjustment equipment host 11 of FIG. 1, the save command for the adjusted parameters is received from the adjustment equipment host 11 on occasion, if necessary, even during the parameter adjustment.

On receiving the save command during the parameter adjustment, the flag 84 provided in the parameter storage area 76 of the nonvolatile memory 34 is checked, and the adjusted parameters are saved in accordance with the set state or the reset state of the flag 84.

As shown in, for example, FIG. 7, in a case where the flag 84 provided in the parameter storage area 76 of the nonvolatile memory 34 is reset to F=0, when the save command for the adjusted parameters is received, all of the adjusted parameters are saved in the parameter storage area 76 of the nonvolatile memory 34.

On the other hand, as shown in, for example, FIG. 8, in a case where the flag 84 provided in the parameter storage area 76 of the nonvolatile memory 34 is set to F=1, when the save command for the adjusted parameters is received, adjusted parameters P1 in the table area 56-1 of the parameter table 56 shown in FIG. 4 are saved in the parameter storage area 76 of the nonvolatile memory 34. On the other hand, adjusted parameters P2 in the table area 56-2 of the parameter table 56 of FIG. 4 are saved in the parameter storage area 80 in the system area of the magnetic disk 22-1.

Furthermore, as shown in FIG. 9, also when data other than the parameters, for example, the restoration code 86 in compliance with the increase of the functions of the firmware is saved in the free area of the nonvolatile memory 34, the flag 84 provided in the parameter storage area 76 is checked. In a case where the flag 84 is set to F=1, it is determined that the free area is formed in the parameter storage area 76, to save the restoration code 86 in the area.

On the other hand, when the flag 84 is reset to F=0, the entire parameter storage area 76 is used for storing the adjusted parameters, and any free area is not present, whereby the save command for the restoration code finishes due to an error.

This can securely prevent the adjusted parameters from being lost by writing information such as the restoration code other than the parameter by mistake while all of the adjusted parameters are stored in the parameter storage area 76 of the nonvolatile memory 34.

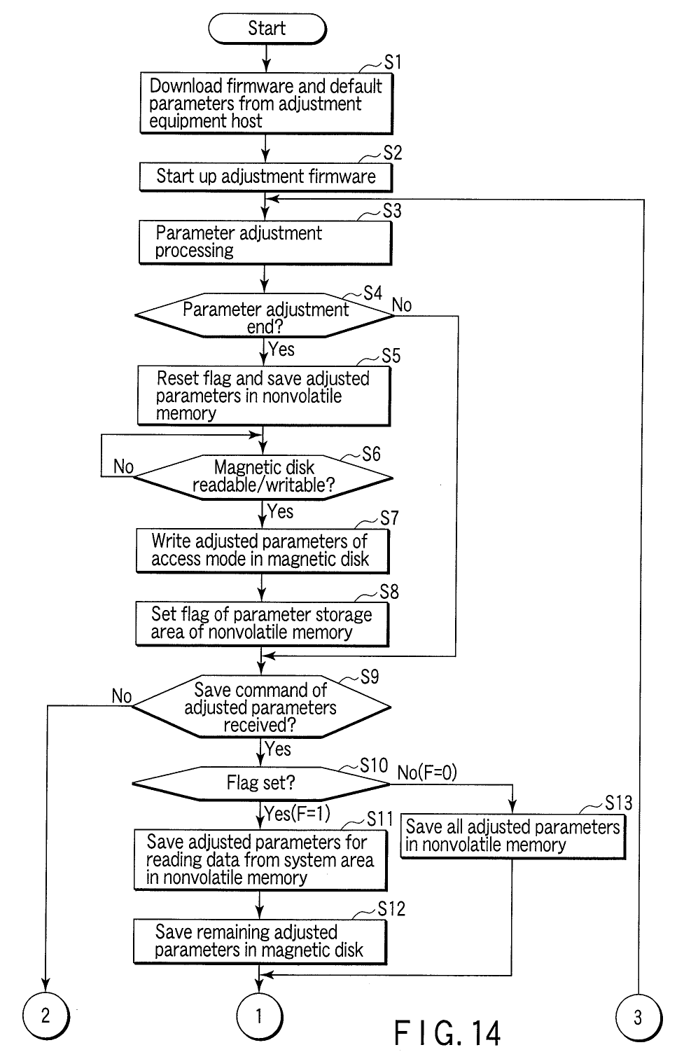

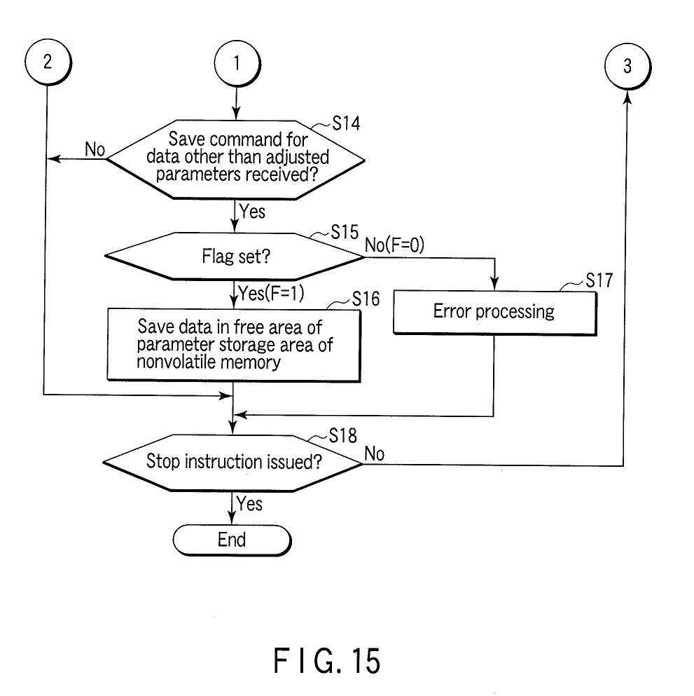

FIGS. 14 and 15 are flow charts showing parameter adjustment processing in the magnetic disk drive of the embodiment. Next, the processing will be described with reference to FIG. 1.

In FIG. 14, in the parameter adjustment processing of the embodiment, first in step S1, the adjustment firmware and the default parameters are downloaded into the volatile memory 32 from the adjustment equipment host 11, and further saved in the nonvolatile memory 34. Next, in step S2, the downloaded adjustment firmware is started to execute the parameter adjustment processing in step S3.

Next, in step S4, it is checked whether or not the parameter adjustment finishes. When the parameter adjustment finishes, processing advances to step S5 in which all of the adjusted parameters are saved in the nonvolatile memory 34 while the flag 84 is reset to F=0 as shown in FIG. 7.

Next, it is checked in step S6 whether or not the data can be read or written from or to the magnetic disk. If the data can be read or written, in step S7, adjusted parameters P2 other than parameters P1 saved in the nonvolatile memory 34 as the minimum parameters necessary for reading the data from the system area are written and saved in the system area of the magnetic disk. Next, in step S8, the flag 84 in the nonvolatile memory 34 is set to F=1.

Next, it is checked in step S9 whether or not the save command for the adjusted parameters has been received from the adjustment equipment host 11. It is also checked whether or not the save command has been received in a case where the parameter adjustment does not finish in step S4.

In a case where it is determined that the save command for the adjusted parameters has been received, processing advances to step S10 to check whether or not the flag 84 in the nonvolatile memory 34 is set at this time. When the flag 84 is set to F=1, in step S11, adjusted parameters P1 received in the system area are saved in the nonvolatile memory 34, and in step S12, the other adjusted parameters P2 are saved in the system area of the magnetic disk 22-1.

On the other hand, in a case where it is determined in step S10 that the flag 84 is reset to F=0, processing advances to step S13 to save all of the adjusted parameters in the nonvolatile memory 34.

Next, processing advances to step S14 of FIG. 15 to check whether or not the save command for data other than the adjusted parameters has been received. In a case where it is determined that the save command for the data other than the adjusted parameters, for example, the save command for the restoration code in compliance with the increase of the functions of the firmware is received, processing advances to step S15 to check whether or not the flag 84 in the nonvolatile memory 34 is set.

When the flag 84 is set to F=1, processing advances to step S16 to save, for example, the restoration code 86 in the free area in the parameter storage area 76 of the nonvolatile memory 34 as shown in FIG. 9.

On the other hand, in a case where it is determined in step S15 that the flag 84 is reset to F=0, processing advances to step S17 to perform error processing for indicating an error caused termination of the save command received in step S14. The processing of steps S3 to S17 is repeated until a stop instruction by log-off or the like is issued.

Here, in a case where it is determined in step S18 that the stop instruction is issued, the firmware downloaded in step S1, that is, the adjustment firmware is deleted. This is because the firmware is not necessary after the adjustment step finishes.

Needless to say, the adjustment firmware is left as it is, and saved even after the shipment of the magnetic disk drive, whereby the parameters may be readjusted if necessary during use by the user.

Moreover, according to the invention, there is provided a parameter adjustment program used in the adjustment step of the magnetic disk drive 10, and this program has contents shown in the flow charts of FIGS. 14 and 15.

It is to be noted that the parameters stored in the parameter table 56 described above in the embodiment with reference to FIG. 4 have contents shown in, for example, the parameter list of FIG. 5. However, all of the parameters are not adjustment targets, but the parameters in the parameter table 56 include two types, that is, the parameter used as the default parameter as it is and the parameter actually needed to be adjusted by the magnetic disk drive itself. Both the parameters are referred to as the adjusted parameters.

Examples of a stationary parameter for the magnetic disk drive include a parameter for setting a decode system with respect to a read modulation module, and a parameter for setting an encode system with respect to a write modulation module.

Moreover, the invention can be applied to a storage medium (drive) device such as a magnetic disk drive or an optical disk drive.

Furthermore, the invention includes appropriate modification without impairing its object and advantage, and is further not restricted by numeric values shown above in the embodiment.

1.-20. (canceled)

21. A storage device comprising:
a recording/reproducing module configured to position a head at a position of a storage medium to record or reproduce data;
a nonvolatile memory comprising a parameter storage area;
an adjustment module configured to adjust a plurality of types of parameters to be used for the control of the recording/reproducing module;
a parameter saving module configured to store the adjusted parameters in the nonvolatile memory during adjustment and to store a portion of the adjusted parameters in the nonvolatile memory to the storage medium at the end of the parameter adjustment in order to generate a free space in the parameter storage area; and
a free space allocator configured to allocate the free space of the nonvolatile memory as a storage area for data other than the parameters.

22. The storage device of claim 21, wherein the parameter saving module is configured to keep first parameters to be used for reading data from a system area of the storage medium in the nonvolatile memory while booting the device by power activation, and to store second parameters which is not the first parameters in the storage medium.

23. The storage device of claim 22, wherein:
the nonvolatile memory comprises a flag comprising a reset state as an initial state in the parameter storage area; and
the parameter saving module is configured to set the flag when a portion of the adjusted parameters in the nonvolatile memory is written and stored in the storage medium.

24. The storage device of claim 23, wherein the parameter saving module is configured to save the adjusted parameters in the nonvolatile memory if the flag is reset when a command indicative of storing the adjusted parameters is received, and to separately store the adjusted parameters in the nonvolatile memory and the storage medium in accordance with the contents of the adjusted parameters if the flag is set.

25. The storage device of claim 23, further comprising a parameter loader configured to read the adjusted parameters from the nonvolatile memory and the storage medium in accordance with the state of the flag while booting up the storage device by the power activation, and to load the adjusted parameters into a volatile memory.

26. The storage device of claim 25, wherein the parameter loader is configured to load the parameters into the volatile memory from the nonvolatile memory when the flag is reset at the startup by the power activation, to load a first portion of the parameters into the volatile memory from the nonvolatile memory and to load a second portion of the parameters into the volatile memory from the storage medium when the flag is set.

27. The storage device of claim 21, wherein the free space allocator is configured to allocate the free space as a storage area for firmware or a storage area for a log.

28. The storage device of claim 23, wherein the free space allocator is configured to allow the data to be stored if the flag is set when a command indicative of storing the firmware, a log or data which are not the parameters in the nonvolatile memory is received, and to prohibit the storing and to determine an error occurrence if the flag is reset.

29. A control method for a storage device which comprises a recording/reproducing module configured to position a head at an arbitrary position of a storage medium to record or to reproduce data and a nonvolatile memory comprising a parameter storage area, the control method comprising:
adjusting various types of parameters for the control of the recording/reproducing module;
storing the adjusted parameters obtained by the adjustment process in the nonvolatile memory during adjustment;
storing a portion of the adjusted parameters in the nonvolatile memory into the storage medium at the end of the parameter adjustment to generate a free space in the parameter storage area; and
a free space allocator configured to allocate the free space of the nonvolatile memory as a storage area for data other than the parameters.

30. The control method for the storage device of claim 29, wherein the storing the adjusted parameter, comprising keeping first parameters to be used for reading data from a system area of the storage medium in the nonvolatile memory while booting the device by power activation, and storing second parameters which is not the first parameters in the storage medium.

31. The control method for the storage device of claim 29, wherein the nonvolatile memory comprises a flag comprising a reset state as an initial state in the parameter storage area, further comprising:
setting the flag when a portion of the adjusted parameters in the nonvolatile memory is written and stored in the storage medium.

32. The control method for the storage device of claim 31, further comprising:
storing the adjusted parameters in the nonvolatile memory if the flag is reset when a command indicative of storing the adjusted parameters is received; and storing the adjusted parameters in the nonvolatile memory and the storage medium separately in accordance with the contents of the adjusted parameters if the flag is set.

33. The control method for the storage device of claim 31, further comprising:
reading the adjusted parameters from the nonvolatile memory and/or the storage medium in accordance with the state of the flag while booting the storage device by the power activation; and
loading the adjusted parameters into a volatile memory.

34. The control method for the storage device of claim 33, further comprising:
loading the parameters into the volatile memory from the nonvolatile memory when the flag is reset while booting the storage device by the power activation;
loading a first portion of the parameters into the volatile memory from the nonvolatile memory; and
loading a second portion of parameters into the volatile memory from the storage medium when the flag is set.

35. The control method for the storage device of claim 29, further comprising:
allocating the free space as a storage area for firmware or a storage area for a log.

36. The control method for a storage device of claim 31, further comprising:
allowing the data to be stored if the flag is set when a command indicative of storing the firmware, a log or the like other than the parameters in the nonvolatile memory is received; and
prohibiting the storing and determining an error occurrence if the flag is reset.

37. A controller for controlling a storage device configured to position a head at a position of a storage medium to record or reproduce data, comprising:
an adjustment module configured to adjust a plurality of types of parameters to be used for the control of the recording/reproducing;
a parameter saving module configured to store the adjusted parameters obtained by the adjustment module in a nonvolatile memory during adjustment and to store a portion of the adjusted parameters in the nonvolatile memory to the storage medium at the end of the parameter adjustment in order to generate a free space in a parameter storage area defined in the nonvolatile memory; and
a free space allocator configured to allocate the free space of the nonvolatile memory as a storage area for data other than the parameters.

38. The controller of claim 37, wherein the parameter saving module is configured to keep first parameters to be used for reading data from a system area of the storage medium in the nonvolatile memory while booting the device by power activation, and to store second parameters in the storage medium.

39. The controller of claim 38, wherein:
the nonvolatile memory comprises a flag comprising a reset state as an initial state in the parameter storage area; and
the parameter saving module is configured to set the flag when a portion of the adjusted parameters in the nonvolatile memory is written and stored in the storage medium.

40. The controller of claim 39, wherein the parameter saving module is configured to save the adjusted parameters in the nonvolatile memory if the flag is reset when a command indicative of storing the adjusted parameters is received, and to separately store the adjusted parameters in the nonvolatile memory and the storage medium in accordance with the contents of the adjusted parameters if the flag is set.
